(19) United States
(12) Patent Application Publication
(10) Pub. No.: US 2026/0052438 A1
(43) Pub. Date: Feb. 19, 2026

(54) RRM MEASUREMENT ON MULTIPLE CANDIDATE SCGS

(71) Applicant: APPLE INC., Cupertino, CA (US)

(72) Inventors: Qiming Li, Beijing (CN); Yuexia Song, Beijing (CN); Dawei Zhang, Saratoga, CA (US); Yang Tang, San Jose, CA (US); Jie Cui, San Jose, CA (US); Manasa Raghavan, Sunnyvale, CA (US); Xiang Chen, Campbell, CA (US); Rolando E. Bettancourt Ortega, Munich (DE)

(21) Appl. No.: 18/996,183

(22) PCT Filed: Aug. 4, 2022
(86) PCT No.: PCT/CN2022/110240

§ 371 Date: Jan. 17, 2025

(51) Int. Cl. H04W 36/00; H04B 7/06; H04L 5/00

(52) U.S. Cl. CPC H04W 36/0085; H04B 7/0626; H04L 5/0098

(57) ABSTRACT

The present disclosure relates to RRM measurement on multiple candidate SCGs. In an aspect, a wireless device may comprise at least one antenna; at least one radio coupled to the at least one antenna; and a processor coupled to the at least one radio; wherein the processor is configured to receive, via the at least one radio, one or more reference signals from a cellular base station; and perform Radio Resource Management (RRM) measurement outside a Measurement Gap (MG) on the one or more reference signals on a Primary Component Carrier (PCC) using a first searcher, and ton one or more Primary Secondary Component Carriers (PSCC) corresponding to a plurality of Secondary Cell Groups (SCG) and a plurality of Secondary Component Carriers (SCC) using a second searcher, wherein the processor is configured to perform the RRM measurement on each carrier of the PCC, the one or more PSCCs and the plurality of SCCs based on a respective measurement cycle.

### TECHNICAL FIELD

This application relates generally to wireless communication systems, including wireless device, cellular base station, methods, apparatus for Radio Resource Management (RRM) measurement on multiple candidate Secondary Cell Groups (SCG).

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a or g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

Frequency bands for 5G NR may be separated into two or more different frequency ranges. For example, Frequency Range 1 (FR1) may include frequency bands operating in sub-6 GHz frequencies, some of which are bands that may be used by previous standards, and may potentially be extended to cover new spectrum offerings from 410 MHz to 7125 MHz. Frequency Range 2 (FR2) may include frequency bands from 24.25 GHz to 52.6 GHz. Bands in the millimeter wave (mmWave) range of FR2 may have smaller coverage but potentially higher available bandwidth than bands in the FR1. Skilled persons will recognize these frequency ranges, which are provided by way of example, may change from time to time or from region to region.

### SUMMARY

Embodiments relate to device, method, apparatus, computer-readable storage medium and computer program product for wireless communication.

According to an aspect, there is provided a wireless device, comprising: at least one antenna; at least one radio coupled to the at least one antenna; and a processor coupled to the at least one radio; wherein the processor is configured to receive, via the at least one radio, one or more reference signals from a cellular base station; and perform Radio Resource Management (RRM) measurement outside a Measurement Gap (MG) on the one or more reference signals on a Primary Component Carrier (PCC) using a first searcher, and to on one or more Primary Secondary Component Carriers (PSCC) corresponding to a plurality of Secondary Cell Groups (SCG) and a plurality of Secondary Component Carriers (SCC) using a second searcher, wherein the processor is configured to perform the RRM measurement on each carrier of the PCC, the one or more PSCCs and the plurality of SCCs based on a respective measurement cycle.

According to another aspect, there is provided a cellular base station, comprising: at least one antenna; at least one radio coupled to the at least one antenna; and a processor coupled to the at least one radio; wherein the processor is configured to: transmit, via the at least one radio, a first Radio Resource Control (RRC) message for Radio Resource Management (RRM) measurement outside a Measurement Gap (MG) to a wireless device, wherein, the first RRC message indicates which Primary Secondary Component Carrier (PSCC) among one or more PSCCs corresponding to a plurality of Secondary Cell Groups (SCG) is an anchor PSCC; and receive, via the at least one radio, a measurement report regarding the RRM measurement from the wireless device.

According to another aspect, there is provided a method for a wireless device, comprising: receiving one or more reference signals from a cellular base station; and performing Radio Resource Management (RRM) measurement outside a Measurement Gap (MG) on a Primary Component Carrier (PCC) using a first searcher, and on a one or more Primary Secondary Component Carriers (PSCC) corresponding to a plurality of Secondary Cell Groups (SCG) and a plurality of Secondary Component Carriers (SCC) using a second searcher, wherein the method comprising performing the RRM measurement on each carrier of the PCC, the one or more PSCCs and the plurality of SCCs based on a respective measurement cycle.

According to another aspect, there is provided a method for a cellular base station, comprising transmitting a first Radio Resource Control (RRC) message for Radio Resource Management (RRM) measurement outside a Measurement Gap (MG) to a wireless device, wherein, the first RRC message indicates which Primary Secondary Component Carrier (PSCC) among one or more PSCCs corresponding to a plurality of Secondary Cell Groups (SCG) is an anchor PSCC; and receiving a measurement report regarding the RRM from the wireless device.

According to another aspect, there is provided an apparatus, comprising: a processor configured to cause a wireless device to: receive, via the at least one radio, one or more reference signals from a cellular base station; and perform Radio Resource Management (RRM) measurement outside a Measurement Gap (MG) on the one or more reference signals on a Primary Component Carrier (PCC) using a first searcher, and to perform the RRM measurement on one or more Primary Secondary Component Carriers (PSCC) corresponding to a plurality of Secondary Cell Groups (SCG) and a plurality of Secondary Component Carriers (SCC) using a second searcher, wherein the processor is further configured to perform the RRM measurement on each carrier of the PCC, the one or more PSCCs and the plurality of SCCs based on a respective measurement cycle.

According to another aspect, there is provided computer-readable storage medium storing program instructions, wherein the program instructions, when executed by a computer system, cause the computer system to perform the method of any of the above aspects.

According to another aspect, there is provided a computer program product, comprising program instructions which, when executed by a computer, cause the computer to perform the method of any of the above aspects.

The techniques described herein may be implemented in and/or used with a number of different types of devices, including but not limited to cellular phones, tablet computers, wearable computing devices, portable media players, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example architecture of a wireless communication system, according to embodiments disclosed herein.

FIG. 2 illustrates a system for performing signaling between a wireless device and a network device, according to embodiments disclosed herein.

FIG. 3 illustrates a typical configuration of NR Dual Connection (DC).

FIG. 4 illustrates an example of measurement cycles for RRM measurement on a PCC, one or more PSCCs corresponding to a plurality of SCGs and a plurality of SCCs according to a first embodiment of the present disclosure.

FIG. 5 illustrates an example RRC message according to a second embodiment of the present disclosure.

FIG. 6 illustrates an example of measurement cycles for RRM measurement on a PCC, one or more PSCCs corresponding to a plurality of SCGs and a plurality of SCCs according to the second embodiment of the present disclosure.

FIG. 7 illustrates an example flow diagram for a wireless device according to the present disclosure.

FIG. 8 illustrates an example flow diagram for a network device according to the present disclosure.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

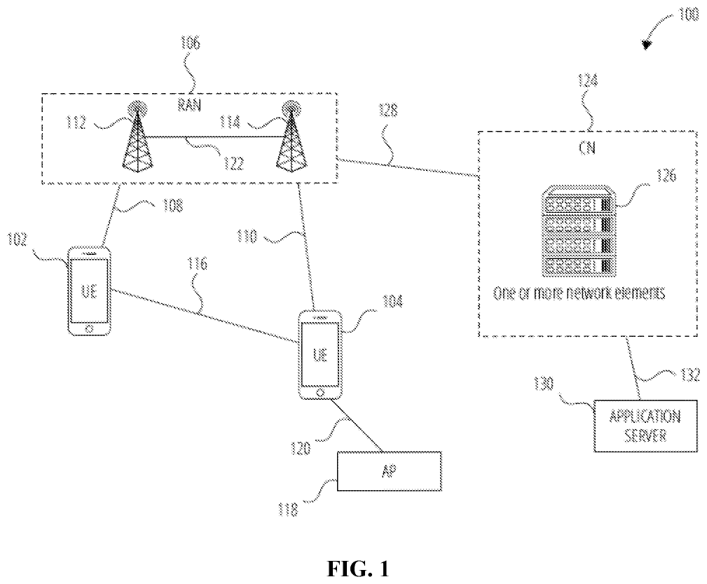

FIG. 1 illustrates an example architecture of a wireless communication system 100, according to embodiments disclosed herein. The following description is provided for an example wireless communication system 100 that operates in conjunction with the LTE system standards and/or 5G or NR system standards as provided by 3GPP technical specifications.

As shown by FIG. 1, the wireless communication system 100 includes UE 102 and UE 104 (although any number of UEs may be used). In this example, the UE 102 and the UE 104 are illustrated as smartphones (e.g., handheld touchscreen mobile computing devices connectable to one or more cellular networks), but may also comprise any mobile or non-mobile computing device configured for wireless communication.

The UE 102 and UE 104 may be configured to communicatively couple with a RAN 106. In embodiments, the RAN 106 may be NG-RAN, E-UTRAN, etc. The UE 102 and UE 104 utilize connections (or channels) (shown as connection 108 and connection 110, respectively) with the RAN 106, each of which comprises a physical communications interface. The RAN 106 can include one or more base stations, such as base station 112 and base station 114, that enable the connection 108 and connection 110.

In this example, the connection 108 and connection 110 are air interfaces to enable such communicative coupling, and may be consistent with RAT(s) used by the RAN 106, such as, for example, an LTE and/or NR.

In some embodiments, the UE 102 and UE 104 may also directly exchange communication data via a sidelink interface 116. The UE 104 is shown to be configured to access an access point (shown as AP 118) via connection 120. By way of example, the connection 120 can comprise a local wireless connection, such as a connection consistent with any IEEE 802.11 protocol, wherein the AP 118 may comprise a Wi-Fi® router. In this example, the AP 118 may be connected to another network (for example, the Internet) without going through a CN 124.

In embodiments, the UE 102 and UE 104 can be configured to communicate using orthogonal frequency division multiplexing (OFDM) communication signals with each other or with the base station 112 and/or the base station 114 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 112 or base station 114 may be implemented as one or more software entities running on server computers as part of a virtual network. In addition, or in other embodiments, the base station 112 or base station 114 may be configured to communicate with one another via interface 122. In embodiments where the wireless communication system 100 is an LTE system (e.g., when the CN 124 is an EPC), the interface 122 may be an X2 interface. The X2 interface may be defined between two or more base stations (e.g., two or more eNBs and the like) that connect to an EPC, and/or between two eNBs connecting to the EPC. In embodiments where the wireless communication system 100 is an NR system (e.g., when CN 124 is a 5GC), the interface 122 may be an Xn interface. The Xn interface is defined between two or more base stations (e.g., two or more gNBs and the like) that connect to 5GC, between a base station 112 (e.g., a gNB) connecting to 5GC and an eNB, and/or between two eNBs connecting to 5GC (e.g., CN 124).

The RAN 106 is shown to be communicatively coupled to the CN 124. The CN 124 may comprise one or more network elements 126, which are configured to offer various data and telecommunications services to customers/subscribers (e.g., users of UE 102 and UE 104) who are connected to the CN 124 via the RAN 106. The components of the CN 124 may be implemented in one physical device or separate physical devices including components to read and execute instructions from a machine-readable or computer-readable medium (e.g., a non-transitory machine-readable storage medium).

In embodiments, the CN 124 may be an EPC, and the RAN 106 may be connected with the CN 124 via an S1 interface 128. In embodiments, the S1 interface 128 may be split into two parts, an S1 user plane (S1-U) interface, which carries traffic data between the base station 112 or base station 114 and a serving gateway (S-GW), and the S1-MME interface, which is a signaling interface between the base station 112 or base station 114 and mobility management entities (MMEs).

In embodiments, the CN 124 may be a 5GC, and the RAN 106 may be connected with the CN 124 via an NG interface 128. In embodiments, the NG interface 128 may be split into two parts, an NG user plane (NG-U) interface, which carries traffic data between the base station 112 or base station 114 and a user plane function (UPF), and the S1 control plane (NG-C) interface, which is a signaling interface between the base station 112 or base station 114 and access and mobility management functions (AMFs).

Generally, an application server 130 may be an element offering applications that use internet protocol (IP) bearer resources with the CN 124 (e.g., packet switched data services). The application server 130 can also be configured to support one or more communication services (e.g., VoIP sessions, group communication sessions, etc.) for the UE 102 and UE 104 via the CN 124. The application server 130 may communicate with the CN 124 through an IP communications interface 132.

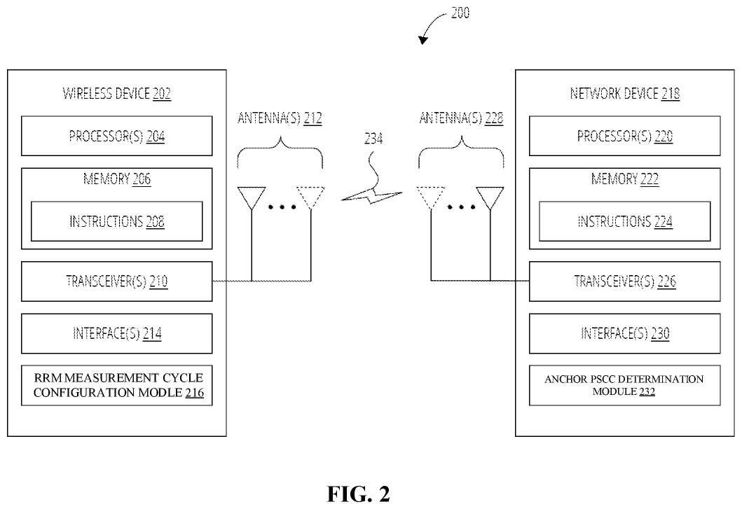

FIG. 2 illustrates a system 200 for performing signaling 234 between a wireless device 202 and a network device 218, according to embodiments disclosed herein. The system 200 may be a portion of a wireless communications system as herein described. The wireless device 202 may be, for example, a UE of a wireless communication system. The network device 218 may be, for example, a base station (e.g., an eNB or a gNB) of a wireless communication system.

The wireless device 202 may include one or more processor(s) 204. The processor(s) 204 may execute instructions such that various operations of the wireless device 202 are performed, as described herein. The processor(s) 204 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 202 may include a memory 206. The memory 206 may be a non-transitory computer-readable storage medium that stores instructions 208 (which may include, for example, the instructions being executed by the processor(s) 204). The instructions 208 may also be referred to as program code or a computer program. The memory 206 may also store data used by, and results computed by, the processor(s) 204.

The wireless device 202 may include one or more transceiver(s) 210 that may include radio frequency (RF) transmitter and/or receiver circuitry that use the antenna(s) 212 of the wireless device 202 to facilitate signaling (e.g., the signaling 234) to and/or from the wireless device 202 with other devices (e.g., the network device 218) according to corresponding RATs.

The wireless device 202 may include one or more antenna(s) 212 (e.g., one, two, four, or more). For embodiments with multiple antenna(s) 212, the wireless device 202 may leverage the spatial diversity of such multiple antenna(s) 212 to send and/or receive multiple different data streams on the same time and frequency resources. This behavior may be referred to as, for example, multiple input multiple output (IMO) behavior (referring to the multiple antennas used at each of a transmitting device and a receiving device that enable this aspect). MIMO transmissions by the wireless device 202 may be accomplished according to precoding (or digital beamforming) that is applied at the wireless device 202 that multiplexes the data streams across the antenna(s) 212 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 202 may implement analog beamforming techniques, whereby phases of the signals sent by the antenna(s) 212 are relatively adjusted such that the (joint) transmission of the antenna(s) 212 can be directed (this is sometimes referred to as beam steering).

The wireless device 202 may include one or more interface(s) 214. The interface(s) 214 may be used to provide input to or output from the wireless device 202. For example, a wireless device 202 that is a UE may include interface(s) 214 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 210/antenna(s) 212 already described) that allow for communication between the UE and other devices and may operate according to known protocols (e.g., Wi-Fi®, Bluetooth®, and the like).

The wireless device 202 may include a RRM measurement cycle configuration module 216. The RRM measurement cycle configuration module 216 may be implemented via hardware, software, or combinations thereof. For example, the RRM measurement cycle configuration module 216 may be implemented as a processor, circuit, and/or instructions 208 stored in the memory 206 and executed by the processor(s) 204. In some examples, the RRM measurement cycle configuration module 216 may be integrated within the processor(s) 204 and/or the transceiver(s) 210. For example, the RRM measurement cycle configuration module 216 may be implemented by a combination of software components (e.g., executed by a DSP or a general processor) and hardware components (e.g., logic gates and circuitry) within the processor(s) 204 or the transceiver(s) 210.

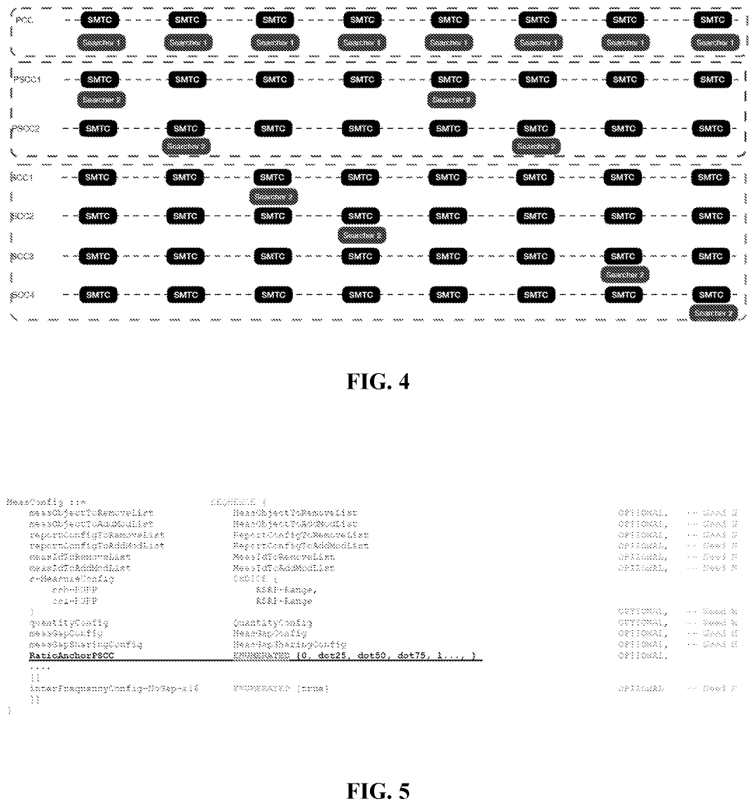

The RRM measurement cycle configuration module 216 may be used for various aspects of the present disclosure, for example, aspects of FIGS. 4-6. The RRM measurement cycle configuration module 216 is configured to configure respective measurement cycles for RRM measurement on each carrier of the PCC, one or more PSCCs corresponding to a plurality of SCGs and the plurality of SCCs.

The network device 218 may include one or more processor(s) 220. The processor(s) 220 may execute instructions such that various operations of the network device 218 are performed, as described herein. The processor(s) 204 may include one or more baseband processors implemented using, for example, a CPU, a DSP, an ASIC, a controller, an FPGA device, another hardware device, a firmware device, or any combination thereof configured to perform the operations described herein.

The network device 218 may include a memory 222. The memory 222 may be a non-transitory computer-readable storage medium that stores instructions 224 (which may include, for example, the instructions being executed by the processor(s) 220). The instructions 224 may also be referred to as program code or a computer program. The memory 222 may also store data used by, and results computed by, the processor(s) 220.

The network device 218 may include one or more transceiver(s) 226 that may include RF transmitter and/or receiver circuitry that use the antenna(s) 228 of the network device 218 to facilitate signaling (e.g., the signaling 234) to and/or from the network device 218 with other devices (e.g., the wireless device 202) according to corresponding RATs.

The network device 218 may include one or more antenna(s) 228 (e.g., one, two, four, or more). In embodiments having multiple antenna(s) 228, the network device 218 may perform IMO, digital beamforming, analog beamforming, beam steering, etc., as has been described.

The network device 218 may include one or more interface(s) 230. The interface(s) 230 may be used to provide input to or output from the network device 218. For example, a network device 218 that is a base station may include interface(s) 230 made up of transmitters, receivers, and other circuitry (e.g., other than the transceiver(s) 226/antenna(s) 228 already described) that enables the base station to communicate with other equipment in a core network, and/or that enables the base station to communicate with external networks, computers, databases, and the like for purposes of operations, administration, and maintenance of the base station or other equipment operably connected thereto.

The network device 218 may include an anchor PSCC determination module 232. The anchor PSCC determination module 232 may be implemented via hardware, software, or combinations thereof. For example, the anchor PSCC determination module 232 may be implemented as a processor, circuit, and/or instructions 224 stored in the memory 222 and executed by the processor(s) 220. In some examples, the anchor PSCC determination module 232 may be integrated within the processor(s) 220 and/or the transceiver(s) 226. For example, the anchor PSCC determination module 232 may be implemented by a combination of software components (e.g., executed by a DSP or a general processor) and hardware components (e.g., logic gates and circuitry) within the processor(s) 220 or the transceiver(s) 226.

The anchor PSCC determination module 232 may be used for various aspects of the present disclosure. The anchor PSCC determination module 232 is configured to determine which PSCC among one or more PSCCs corresponding to a plurality of SCGs is an anchor PSCC.

The following description will take 5G NR as an example to illustrate the concept of the present disclosure, but it should be understood that the solution of the present disclosure is applicable to any appropriate mobile communication technology (e.g. 6G or any applicable advanced mobile communication technology).

In the following description, gNB is sometimes used to represent the control device at the base station side in a wireless communication network. It should be understood this is for illustrative purpose only but not restrictive. A base station based on any appropriate mobile communication technology is applicable.

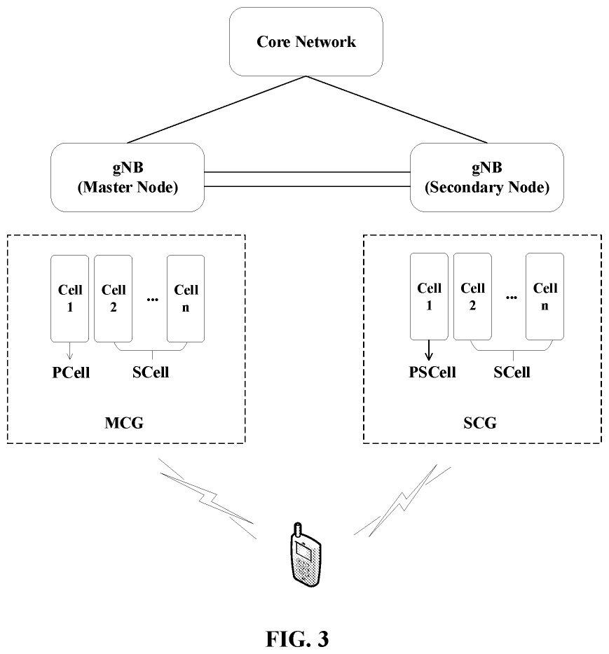

New Radio-Dual Connectivity (NR-DC) has been proposed for enhancing the coverage and capacity for example. Under NR-DC, a UE can simultaneously be connected to two group of cells (e.g. typically, each group of cell corresponding to a gNB). FIG. 3 illustrates a typical configuration of NR-DC.

As illustrated in FIG. 3, under NR-DC, the UE can simultaneously be connected to a master node which serves to interact with the control plane of the core network and a secondary node. Carrier Aggregation (CA) can be applied for both the master node and the secondary node. The group of cells aggregated under the master node is called the Master Cell Group (MCG), and the group of cells aggregated under the secondary node is called the Secondary Cell Group (SCG). The MCG may comprise at least two cells, the primary cell of the MCG is called the Primary Cell (PCell), and the rest cell(s) of the MCG is called Secondary Cell (SCell). The SCG may comprise at least two cells, the primary cell of the SCG is called the Primary Secondary Cell (PSCell), and the rest cell(s) of the SCG is also called Secondary Cell (SCell). Each cell of the PCell, PSCell and SCells may be configured on a respective carrier. The carrier corresponding to the PCell (i.e. on which the PCell is configured) is called Primary Component Carrier (PCC). The carrier corresponding to the PSCell (i.e. on which the PSCell is configured) is called Primary Secondary Component Carrier (PSCC). The carrier corresponding to the SCell (i.e. on which the SCell is configured) is called Secondary Component Carrier (SCC). There could be multiple cells configured on the same carrier as long as such a configuration would not cause interference.

As the developing of various application scenarios, for example, higher requirement for robustness and latency is needed. Configuring multiple candidate SCGs may be a solution to enhance the mobility. For examples, configuring multiple candidate SCGs may enable to realize selective activation of SCGs, and to realize Conditional PSCell Change (CPC) or Conditional PSCell Addition (CPA), which may improve the robustness and reduce the latency of handover.

When multiple candidate SCGs are configured, under each SCG, there will be a PSCell and one or more SCells. Therefore, overall, there can be a plurality of candidate PSCells configured on one or more PSCCs. Note that, normally, the plurality of PSCells are configured on a corresponding plurality of PSCCs. Since only one SCG among the multiple candidate SCGs can be active at one time, it is allowed for PSCells of any two SCGs to share a same central frequency/bandwidth, i.e. to be configured on a same Component Carrier (CC). Therefore, one or more PSCCs may correspond to multiple candidate SCGs.

Typically, under NR-DC, the UE performs RRM measurement (e.g. for Cell selection, Cell reselection and handover, etc.) on each carrier corresponding to each cell configured in MCG and SCG. If multiple candidate SCGs are configured, since more cells to be measured are involved, the RRM measurement will become more complicated.

Therefore, there is a need to provide a solution to enable RRM measurement under NR-DC where multiple candidate SCGs are configured. As known in the art, RRM measurement can involve inter-frequency measurement and intra-frequency measurement, and accordingly, can involve RRM measurement outside a Measurement Gap (MG) and RRM measurement within an MG. The present disclosure mainly focuses on the intra-frequency RRM measurement outside an MG and the present solution is mainly provided for the intra-frequency RRM measurement outside an MG. Hereinafter, for simplicity, RRM measurement refers to the intra-frequency RRM measurement outside an MG unless otherwise explicitly defined.

Typically, a UE would not continuously perform RRM measurement in the time domain, but to perform RRM measurement at some specific time windows. Such time windows may appear in the time domain at a certain interval. For example, one time window can be regarded as one opportunity for performing RRM measurement. Typically, a UE may be configured with two searchers to perform RRM measurement, one for RRM measurement on the PCC and one for RRM measurement on the rest carriers. As known in the art, from functionality perspective, the searcher is mainly used for cell identification and RRM measurement, and a searcher may include different hardware and software components, such as a dedicated baseband processor, a buffer, a Radio Frequency (RF) chain, etc. depending on UE implementation. Different searchers can work independently. In other words, a UE can use two searchers to perform RRM measurement on two carriers simultaneously in one time window (one searcher for each carrier), but one searcher can only be used to perform RRM measurement on one single carrier in one time window.

The present disclosure continues to use the assumption that a UE uses a first searcher for RRM measurement on the PCC and a second searcher different from the first searcher for RRM measurement on the rest carriers. While, since the present disclosure intends to enable RRM measurement with multiple candidate SCGs configured, there is a need to assign measurement opportunities for a plurality of carriers including one or more PSCCs on which multiple PSCells of multiple candidate SCGs are configured and a plurality of SCCs on which multiple SCells in the MCG and the SCGs are configured.

In view of the above, in general, the present invention provides a solution in which UE would perform RRM measurement on each carrier of the PCC, one or more PSCCs and the plurality of SCCs based on a respective measurement cycle, such that each measurement opportunity of the first searcher will be assigned to the PCC, and the measurement opportunities of the second searcher can be shared by the one or more PSCCs and the plurality of SCCs.

The present disclosure provides several embodiments for configuring the measurement cycles for different CCs. The details of these embodiments will be described hereinafter.

According to the first embodiment of the present disclosure, a UE can receive one or more reference signals (e.g. Synchronization Signal Block (SSB) and/or Channel State Information Reference Signal (CSI-RS) from a base station and perform RRM measurement on the one or more reference signals on each of the one or more PSCCs with a certain measurement cycle (hereinafter, a first measurement cycle or the measurement cycle for the PSCC), and t on each of the SCCs with a certain measurement cycle same or different from the first cycle (hereinafter, a second measurement cycle or the measurement cycle for the SCC), and the UE can configure the first measurement cycle and the second measurement cycle such that all of the PSCC(s) share 50% measurement opportunities of the second searcher and all the plurality of SCCs share the rest 50% measurement opportunities of the second searcher.

FIG. 4 illustrates how the measurement cycles can be configured for different CCs and accordingly how the measurement opportunities can be assigned for different CCs according to the first embodiment of the present disclosure. Note that FIG. 4 illustrates an example measurement configuration assuming that there are two candidate SCGs, and there are two PSCCs in total and four SCCs in total. However, such an assumption is only for the purpose of illustration without limitation. The number of candidate SCGs is not limited to two, and the number of PSCCs and the number of SCCs can be any suitable values.

As mentioned above, a UE would perform RRM measurement at some specific time windows. For SSB based measurement, such a time window is defined as SSB-Based RRM Measurement Timing Configurations (SMTC). For CSI-RS based measurement, a similar time window exists. The periodicity of SMTC can be set to a value selected from a group of values. Similarly, the duration of SMTC can be set to a value selected from a group of values. For simplicity of illustration, FIG. 4 shows the measurement configuration assuming that only the SSB-Based measurement is configured and SMTCs for all the CCs are aligned, that is, the SMTCs for all the CCs share a same duration and a same periodicity (i.e. appear at a same interval).

As shown in FIG. 4, the PCC is measured by the UE using the first searcher, and the first searcher is only used for the PCC. Therefore, the measurement cycle for measuring the PCC is aligned with the periodicity of the measurement time window (i.e. the SMTC in this case).

As further shown in FIG. 4, the UE performs RRM measurement on all the PSCCs and all the SCCs using the second searcher. All the PSCCs (i.e. PSCC1 and PSCC2) together share 50% measurement time windows during which measurement can be performed by the second searcher (i.e. 50% measurement opportunities of the second searcher), and all the SCCs (i.e. SCC1-SCC4) together share the rest 50% measurement time windows during which measurement can be performed by the second searcher (i.e. 50% measurement opportunities of the second searcher). According to the present disclosure, the expression “sharing a certain percentage/ratio of measurement opportunities of the second searcher by a certain group of CCs” means the group of CCs will get an equal chance to be measured under a certain percentage/ratio of general measurement opportunities of the second searcher, that is the certain percentage/ratio of measurement opportunities of the second searcher would be equally assigned to each CC within the group. For example, as shown in FIG. 4, two PSCCs share 50% measurement opportunities of the second searcher, therefore, each PSCC gets 25% measurement opportunities of the second searcher. Therefore, in the case that there are two PSCCs and four SCCs, the measurement cycle for measuring the PSCC (PSCC1 or PSCC2) is four times of the periodicity of the SMTC, and the measurement cycle for measuring the SCC (any of SCC1-SCC4) is eight times of the periodicity of the SMTC. In other words, each PSCC will be measured once every four SMTCs and each SCC will be measured once every eight SMTCs.

As is the case of FIG. 4, generally, the number of PSCCs is smaller than the number of SCCs. Thus, with 50% measurement opportunities being shared by the PSCCs and the rest 50% measurement opportunities being shared by the SCCs, the PSCCs would get more chances to be measured, which is practical because functionally the PSCC plays a more important role than any SCC.

As illustrated in FIG. 4, PSCC1, PSCC2, SCC1, SCC2, SCC3 and SCC4 get the measurement opportunities in turn, while, such a configuration is just illustrative without limitation. For example, the UE can configure any order for measuring PSCC1, PSCC2, SCC1, SCC2, SCC3 and SCC4, as long as the measurement cycles are configured by satisfying 50% measurement opportunities being shared by the PSCCs and the rest 50% measurement opportunities being shared by the SCCs.

Note that FIG. 4 illustrates the measurement opportunity configuration in the case that SMTCs are aligned and the number of SCCs is an integral multiple of the number of PSCCs. In fact, the periodicity and the duration of the SMTC for each CC can be configured as different values. Besides, the number of SCCs and the PSCCs can be arbitrary. According to the present disclosure, more generally, the expression “50% measurement opportunities of the second searcher” means in a relatively long time period, overall, about 50% of the time, the second searcher is allocated for measuring PSCCs, and about 50% of the time, the second searcher is allocated for measuring SCCs. Therefore, a UE is allowed to configure any pattern to configure the measurement cycle of the PSCC and the measurement cycle of the SCC, as long as about 50% of the measurement opportunities of the second searcher are allocated for measuring the PSCC(s) and the rest measurement opportunities of the second searcher are allocated for measuring the SCCs.

According to the first embodiment, the UE may configure the measurement cycle for the PSCC such that the measurement cycle satisfies (in other words, is within) a measurement delay scaled by a first factor for any of the one or more PSCCs corresponding to a plurality of SCGs, wherein the first factor may depend on a number associated with the PSCC(s). As known in the art, for RRM measurement, SSB and CSI-RS can be configured as the measurement items. For one CC, it can be configured that only SSB based Layer-3 measurement, only CSI-RS based Layer-3 measurement, and/or both SSB and CSI-RI based Layer-3 measurement is to be performed on the CC. In view of this, specifically, the first factor may depend on the number of PSCC(s) among the one or more configured PSCCs corresponding to the plurality of SCGs which is configured with only SSB based Layer-3 measurement, as well as the number of PSCC(s) among the one or more configured PSCCs which is configured with either both SSB and CSI-RS based Layer-3 measurement or only CSI-RS based Layer-3 measurement.

Particularly, the first factor can be determined as

$$the first factor = 2 \times ( {N}_{PSCC \_ SSB} + 2 \times {N}_{PSCC \_ CRIRS} )$$

wherein:
N_{PSCC_SSB} refers to a number of configured PSCC with only SSB based Layer-3 measurement configured, and
N_{PSCC_CSIRS} refers to a number of configured PSCC with either both SSB and CSI-RS based Layer-3 measurement configured or only CSI-RS based Layer-3 measurement configured.

According to the present disclosure, the first factor can refer to Carrier Specific Scaling Factor (CSSF). Table 1 shows the respective CSSF for PCC, SCC, PSCC and SCC for RRM measurement outside gap for NR-DC, i.e. CSSF_{outside_gap,i}, wherein i refers to the i^{th} carrier under the context that the CSSF is calculated per carrier. Table 1 is proposed according to the present first embodiment and may comply with the 3GPP standard. Table 1 is designed for the scenario where all serving cells in MCG are in FR1 and all serving cells in SCG are in FR2. While, Table 1 is also applicable to other scenarios. For example, all the serving cells in MCG and all the serving cells in SCG may be in a same frequency range (e.g. FR1 or FR2). For another example, partial of the serving cells in MCG (e.g. the PCC and/or some SCC(s)) may be in FR1 and the rest serving cells in MCG may be in FR2, and partial of the serving cells in SCG (e.g. the PSCC and/or some SCC(s)) may be in FR1 and the rest serving cells in MCG may be in FR2.

The last column of Table 1 defines the CSSR for inter-frequency Measurement Object (MO) with no measurement gap which is a special type of inter-frequency measurement to be performed outside the measurement gap. Since the inter-frequency MO with no measurement gap does not involve the MCG and SCG, the last column of Table 1 is provided only for the purpose of scenario integrity. Besides, in Table 1, the item regarding number of PSCC/SCC_CSIRS are multiplied by 2. This is because when performing CSI-RS based measurement, the UE needs to firstly measure an associated SSB to get some information for measuring the CSI-RS. Therefore, it actually takes two measurement opportunities to measure one CSI-RS.

TABLE 1
CSSF_{outside}_{_{—}}_{gap, i} scaling factor for NR-DC mode

| | | | | CSSF_{outside}_{_{—}}_{gap, i} | CSSF_{outside}_{_{—}}_{gap, i} |
|---|---|---|---|---|---|
| | | | | for FR2 SCC | for inter- |
| | | | | where | frequency MO |
| | | | | neighbour cell | with no |
| | CSSF_{outside}_{_{—}}_{gap, i} | CSSF_{outside}_{_{—}}_{gap, i} | CSSF_{outside}_{_{—}}_{gap, i} | measurement is | measurement |
| Scenario | for FR1 PCC | for FR1 SCC | for FR2 PSCC | not required | gap |
| FR1 + FR2 NR- | 1 + N_{PCC}_{_{—}}_{CSIRS} | 2 × (N_{SCC}_{_{—}}_{SSB} + Y + | 2 × (N_{PSCC}_{_{—}}_{SSB} + | 2 × (N_{SCC}_{_{—}}_{SSB} + Y + | 2 × (N_{SCC}_{_{—}}_{SSB} + Y + |
| DC (FR1 PCell | | 2 × N_{SCC}_{_{—}}_{CSIRS}) | 2 × N_{PSCC}_{_{—}}_{CSIRS}) | 2 × N_{SCC}_{_{—}}_{CSIRS}) | 2 × N_{SCC}_{_{—}}_{CSIRS}) |
| and FR2 PScell) | | | | | |

Note 1:
CSSF_{outside}_{_{—}}_{gap, i} = 1 if no SCell is configured and no inter-frequency MO without gap and only SSB based L3 measurement is configured on PSCC; CSSF_{outside}_{_{—}}_{gap, i} = 2 if no SCell is configured and no inter-frequency MO without gap and either both SSB and CSI-RS based L3 configured or only CSI-RS based L3 measurement is configured on PSCC.
Note 2:
Y is the number of configured inter-frequency SSB based frequency layers without MG that are being measured outside of MG; otherwise, it is 0.
Note 3:
N_{PCC}_{_{—}}_{CSIRS} = 1 if PCC is with either both SSB and CSI-RS based L3 configured or only CSI-RS based L3 measurement configured; otherwise, N_{PCC}_{_{—}}_{CSIRS} = 0.
Note 4:
N_{PSCC}_{_{—}}_{CSIRS} = Number of configured PSCC with either both SSB and CSI-RS based Layer-3 measurement configured or only CSI-RS based Layer-3 measurement configured.
Note 5:
N_{SCC}_{_{—}}_{CSIRS} = Number of configured SCell(s) with either both SSB and CSI-RS based L3 measurement configured or only CSI-RS based L3 measurement configured.
Note 6:
N_{SCC}_{_{—}}_{SSB} = Number of configured SCell(s) with only SSB based L3 measurement configured, which is measured without MG.
Note 7:
N_{PSCC}_{_{—}}_{SSB} refers to a number of configured PSCC with only SSB based Layer-3 measurement configured, which is measured without MG.

As shown in Table 1, the above-mentioned first factor for the PSCC corresponds to the CSSF defined in column 4.

According to a variation of the first embodiment, the ratio of the measurement opportunities of the second searcher to be shared by the PSCC(s) can be any suitable a value and is not limited to 50%. Such a ratio can be predetermined (e.g. negotiated in advance between the gNB and the UE, or specified in the standard to be applied), or can be indicated by a RRC message.

The first embodiment of the present disclosure has been detail described above. With the solution of the first embodiment, RRM measurement on multiple candidates SCGs is enabled, and advantageously, the UE only needs to assign the measurement opportunities to the CCs according to the types of the CC (e.g. whether it is a PSCC or an SCC) and therefore, the implementation at the UE side may be relatively simple.

According to the second embodiment of the present disclosure, a UE can perform RRM measurement on an anchor PSCC of one or more PSCCs corresponding to a plurality of SCGs with a certain measurement cycle (hereinafter, a third measurement cycle or the measurement cycle for the anchor PSCC), and perform RRM measurement on each carrier of one or more non-anchor PSCCs and the plurality of SCCs with a certain measurement cycle (hereinafter, a fourth measurement cycle or the measurement cycle for the non-anchor PSCC and the SCC), wherein said one or more non-anchor PSCCs is all PSCC among the one or more PSCCs corresponding to the plurality of SCGs except the anchor PSCC. The UE can configure the third measurement cycle and the fourth measurement cycle such that the anchor PSCC gets a first ratio (e.g. x %, x being any suitable value from 0 to 100 including 0 and 100) of measurement opportunities of the second searcher, and the one or more non-anchor PSCCs and all the SCCs share a second ratio (e.g. (1−x) %) of measurement opportunities of the second searcher, wherein the first ratio and the second ratio together consist a hundred percent.

Note that 0% and 100% measurement opportunities of the second searcher are provided in order to handle some specific scenarios. For example, under one scenario, if the anchor PSCC gets 0% of measurement opportunities of the second searcher, it can be considered that no PSCC is specified as an anchor PSCC among the one or more PSCCs. In this case, all the PSCC(s) could be considered as non-anchor PSCC(s), and all the PSCC(s) and the SCCs would share the measurement opportunities of the second searcher. While under another scenario, 0% of measurement opportunities of the second searcher for the anchor PSCC may indicate that the UE shall not perform RRM measurement on the anchor PSCC and the UE shall perform RRM measurement on the non-anchor PSCC(s) as well as the SCCs by sharing the measurement opportunities provided by the second searcher. Similarly, under some scenario, 100% of measurement opportunities of the second searcher for the anchor PSCC may indicate that the UE shall perform RRM measurement only on the anchor PSCC and the UE does not need to perform RRM measurement on the non-anchor PSCC(s) and the SCCs.

According to the second embodiment of the present disclosure, there could be several ways to let the UE know which PSCC among the one or more PSCCs corresponding to the plurality of SCGs is the anchor PSCC.

For example, the anchor PSCC can be determined according to the activation state of the SCGs. For example, it can be predetermined (e.g. negotiated in advance between the gNB and the UE, or specified in the standard to be applied) that in the case that one of the plurality of SCGs is active, the anchor PSCC is the PSCC corresponding to the active SCG, and in the case that there is not any active SCG among the plurality of SCGs, the anchor PSCC is the PSCC corresponding to the last active SCG of the plurality of SCGs.

For another example, the network can determine which PSCC of the one or more PSCCs is the anchor PSCC and indicate to the UE via an RRC message. For example, the network can similarly consider the activation sate of the SCGs. If the network determines one of the plurality of SCGs is active, the network can determine the PSCC corresponding to the active SCG as the anchor PSCC, and if the network determines there is not any active SCG among the plurality of SCGs, the network can determine the PSCC corresponding to the last active SCG of the plurality of SCGs as the anchor PSCC. For another example, the network can additionally consider other factors to determine the anchor PSCC. For example, if one of the plurality of SCGs is active, the network can determine the PSCC corresponding to the active SCG as the anchor PSCC, and if there is not any active SCG among the plurality of SCGs and the time since the last active SCG of the plurality of SCGs became inactive does not reach a predetermined threshold, the network can determine the last active SCG as the anchor PSCC, otherwise, if there is not any active SCG among the plurality of SCGs and the time since the last active SCG of the plurality of SCGS became inactive exceeds the predetermined threshold, the network can select the PSCC among the plurality of PSCCs which may be functionally more important than the other PSCC(s) for the US based on any considerable reasons. Once the anchor PSCC is determined at the network side, the PCell or a PSCell (the anchor or not) may send an RRC message indicating the anchor PSCC to the UE.

According to the second embodiment, the first ratio of measurement opportunities of the second searcher for the anchor PSCC and the second ratio of measurement opportunities of the second searcher for the one or more non-anchor PSCCs and all the SCCs can be predetermined (e.g. negotiated in advance between the gNB and the UE, or specified in the standard to be applied), or can be indicated via an RRC message. According to the second embodiment, the first ratio and the second ratio can be configured as any suitable value.

FIG. 5 illustrates an example RRC message according to the second embodiment of the present disclosure. As shown in the underlined line in FIG. 5, an information element RatioAnchorPSCC can be added into the conventional RRC message for measurement configuration. The value of such an information element can for example, be selected from 0, 25%, 50%, 75%, 100% and any other suitable value.

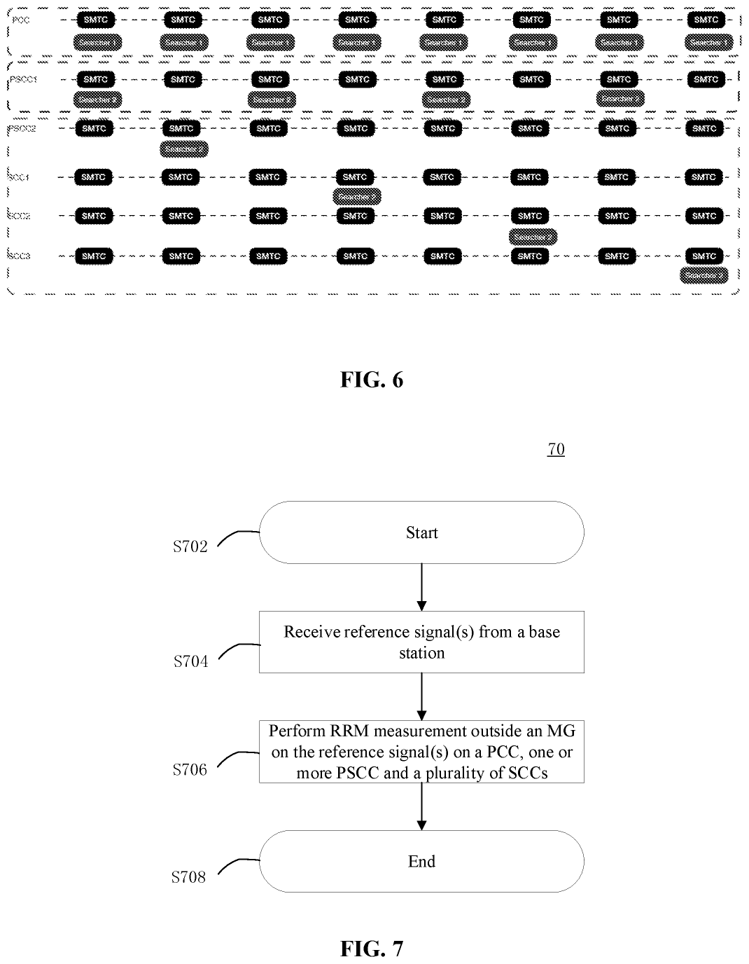

FIG. 6 illustrates in the case that the anchor PSCC gets 50% measurement opportunities of the second searcher and the non-anchor PSCC as well as all the SCCs share the rest 50% measurement opportunities of the second searcher, how the measurement cycles are configured for different CCs and accordingly how the measurement opportunities are assigned for different CCs according to the second embodiment of the present disclosure. Note that FIG. 6 illustrates an example measurement configuration assuming that there are two candidate SCGs, and there are two PSCCs (PSCC1 is the anchor PSCC and PSCC2 is the non-anchor PSCC) and three SCCs. However, such an assumption is only for the purpose of illustration without limitation. The number of candidate SCGs is not limited to two, and the number of PSCCs and the number of SCCs can be any suitable values.

Similar to FIG. 4, FIG. 6 shows the measurement configuration assuming that only the SSB-Based measurement is configured and SMTCs for all the CCs are aligned, that is, the SMTCs for all the CCs share a same duration and a same periodicity (i.e. appear at same intervals).

As shown in FIG. 6, the PCC is measured by the UE using the first searcher, and the first searcher is only used for the PCC. Therefore, the measurement cycle for measuring the PCC is aligned with the periodicity of the measurement time window which in this case is the SMTC.

As further shown in FIG. 6, the UE performs RRM measurement on all the PSCCs and all the SCCs using the second searcher. The anchor PSCC (i.e. PSCC1) gets 50% measurement time windows during which measurement can be performed by the second searcher (i.e. 50% measurement opportunities of the second searcher), and all the non-anchor PSCC(s) (i.e. PSCC2 in this case) and all the SCCs together share the rest 50% measurement time windows during which measurement can be performed by the second searcher (i.e. 50% measurement opportunities of the second searcher). As mentioned above in the first embodiment, according to the present disclosure, the expression “sharing a certain percentage/ratio of measurement opportunities of the second searcher by a certain group of CCs” means the group of CCs will get an equal chance to be measured under a certain percentage/ratio of general measurement opportunities of the second searcher. Accordingly, as shown in FIG. 4, among the non-anchor PSCC (i.e. PSCC1) and all the SCCs (i.e. SCC1-SCC3), each CC gets 12.5% measurement opportunities of the second searcher. Therefore, in the case that there are two PSCCs (one anchor PSCC and one non-anchor PSCC) and three SCCs, the measurement cycle for measuring the anchor PSCC (i.e. PSCC1) is two times of the periodicity of the SMTC, and the measurement cycle for measuring any one of the non-anchor PSCC (i.e. PSCC2) and the SCCs (any of SCC1-SCC3) is eight times of the periodicity of the SMTC. In other words, the anchor PSCC (i.e. PSCC1) will be measured once every two SMTCs, and each CC of the group comprising PSCC2, SCC1, SCC2 and SCC3 will be measured once every eight SMTCs.

As shown in FIG. 6, since there could be only one anchor PSCC, the PSCC would get more chances to be measured which is practical because functionally the anchor PSCC plays a more important role than the non-anchor PSCC and the SCCs.

Similar to the first embodiment, the UE can configure any order for measuring PSCC2, SCC1, SCC2, SCC3 and SCC4, as long as the respective measurement cycles are configured by satisfying 50% measurement opportunities being got by the anchor PSCC and the rest 50% measurement opportunities being shared by the non-anchor PSCC and the SCCs.

Similar to the explanation made with reference to the first embodiment, according to the present disclosure, more generally, the expression “50% measurement opportunities of the second searcher” means in a relatively long time period, overall, about 50% of the time, the second searcher is allocated for measuring the anchor PSCC, and about 50% of the time, the second searcher is allocated for measuring all the non-anchor PSCC(s) and all the SCCs. Therefore, a UE is allowed to configure any pattern to configure the measurement cycle of the anchor PSCC and the measurement cycle of the non-anchor PSCC and the SCC, as long as about 50% of the measurement opportunities of the second searcher are allocated for measuring the anchor PSCC and the rest measurement opportunities of the second searcher are allocated for measuring the non-anchor PSCC(s) and SCCs.

According to the second embodiment, the UE can configure the third measurement cycle and the fourth measurement cycle such that the third measurement cycle satisfies (e.g. is within) a measurement delay scaled by a second factor for the anchor PSCC and the fourth measurement cycle satisfies (e.g. is within) a measurement delay scaled by a third factor for any carrier of the one or more non-anchor PSCCs and all the SCCs, wherein the second factor may depend on a number associated with the anchor PSCC, and the third factor may at least depend on a number associated with the one or more non-anchor PSCCs. Specifically, the second factor may depend on the number of the anchor PSCC which is configured with either both SSB and CSI-RS based Layer-3 measurement or only CSI-RS based Layer-3 measurement (i.e. either 1 or 0 as explained below in Table 2). The third factor may at least depend on the number of non-anchor PSCC(s) which is configured with only SSB based Layer-3 measurement, as well as the number of non-anchor PSCC(s) which is configured with either both SSB and CSI-RS based Layer-3 measurement or only CSI-RS based Layer-3 measurement.

Particularly, in the case that the anchor PSCC gets 50% measurement opportunities of the second searcher, the second factor and the third factor can be determined as

$$the second factor = 2 \times ( 1 + {N}_{anchorPSCC \_ CSIRS} ) ; and$$

$$the third factor = 2 \times ( {N}_{SCC \_ SSB} + Y + 2 \times {N}_{SCC \_ CSIRS} + {N}_{nonanchorPSCC \_ SSB} + 2 \times {N}_{nonanchorPSCC \_ CSIRS} )$$

wherein:
N_{anchorPSCC_CSIRS}=1 if the anchor PSCC is with either both SSB and CSI-RS based Layer-3 measurement configured or only CSI-RS based Layer-3 measurement configured; otherwise,
N_{anchorPSCC_CSIRS}=0,
Y is the number of configured inter-frequency SSB based frequency layers without MG that are being measured outside of MG; otherwise, Y=0,
N_{SCC_SSB} refers to a number of configured SCells with only SSB based Layer-3 measurement configured,
N_{SCC_CSIRS} refers to a number of configured SCell(s) with either both SSB and CSI-RS based Layer-3 measurement configured or only CSI-RS based Layer-3 measurement configured,
N_{nonanchorPSCC_SSB} refers to a number of configured non-anchor PSCC with only SSB based Layer-3 measurement, and
N_{nonanchorPSCC_CSIRS} refers to a number of configured non-anchor PSCC with either both SSB and CSI-RS based Layer-3 measurement configured or only CSI-RS based Layer-3 measurement configured.

According to the present disclosure, similar to the first embodiment, the second factor and the third factor can also refer to Carrier Specific Scaling Factor (CSSF). Table 2 shows the respective CSSF for PCC, SCC, PSCC and SCC (i.e. CSSF_{outside_gap,i}, wherein i refers to the i^{th} carrier under the context that the CSSF is calculated per carrier) for RRM measurement outside gap for NR-DC in the case that the anchor PSCC gets 50% opportunities of the second searcher and the non-anchor PSCC(s) and the SCCs share the rest 50% opportunities of the second searcher. Table 2 is proposed according to the present second embodiment and may comply with the 3GPP standard. Similar to the above described second embodiment, Table 2 is designed for the scenario where all serving cells in MCG are in FR1 and all serving cells in SCG are in FR2, and the last column of Table 2 is provided only for the purpose of scenario integrity.

TABLE 2
CSSF_{outside}_{_{—}}_{gap, i} scaling factor for NR-DC mode

| | | | | CSSF_{outside}_{_{—}}_{gap, i} | |
|---|---|---|---|---|---|
| | | | | for FR2 SCC | CSSF_{outside}_{_{—}}_{gap, i} |
| | | | | and non-anchor | for inter- |
| | | | | PSCC where | frequency MO |
| | | | CSSF_{outside}_{_{—}}_{gap, i} | neighbour cell | with no |
| | CSSF_{outside}_{_{—}}_{gap, i} | CSSF_{outside}_{_{—}}_{gap, i} | for FR2 anchor | measurement is | measurement |
| Scenario | for FR1 PCC | for FR1 SCC | PSCC | not required | gap |
| FR1 + FR2 NR- | 1 + N_{PCC}_{_{—}}_{CSIRS} | 2 × (N_{SCC}_{_{—}}_{SSB} + Y + | 2 × (1 + | 2 × (N_{SCC}_{_{—}}_{SSB} + Y + | 2 × (N_{SCC}_{_{—}}_{SSB} + Y + |
| DC (FR1 PCell | | 2 × N_{SCC}_{_{—}}_{CSIRS}) | N_{anchorPSCC}_{_{—}}_{CSIRS}) | 2 × N_{SCC}_{_{—}}_{CSIRS} + | 2 × N_{SCC}_{_{—}}_{CSIRS}) |
| and FR2 PScell) | | | | N_{nonanchorPSCC}_{_{—}}_{SSB} + 2 × | |
| | | | | N_{nonanchorPSCC}_{_{—}}_{CSIRS}) | |

Note 1:
CSSF_{outside}_{_{—}}_{gap, i} = 1 if no SCell is configured and no inter-frequency MO without gap and only SSB based L3 measurement is configured on PSCC; CSSF_{outside}_{_{—}}_{gap, i} = 2 if no SCell is configured and no inter-frequency MO without gap and either both SSB and CSI-RS based L3 configured or only CSI-RS based L3 measurement is configured on PSCC.
Note 2:
Y is the number of configured inter-frequency SSB based frequency layers without MG that are being measured outside of MG; otherwise, it is 0.
Note 3:
N_{PCC}_{_{—}}_{CSIRS} = 1 if PCC is with either both SSB and CSI-RS based L3 configured or only CSI-RS based L3 measurement configured; otherwise, N_{PCC}_{_{—}}_{CSIRS} = 0.
Note 4:
N_{anchorPSCC}_{_{—}}_{CSIRS} = 1 if the anchor PSCC is with either both SSB and CSI-RS based Layer-3 measurement configured or only CSI-RS based Layer-3 measurement configured; otherwise, N_{anchorPSCC}_{_{—}}_{CSIRS} = 0.
Note 5:
N_{SCC}_{_{—}}_{CSIRS} = Number of configured SCell(s) with either both SSB and CSI-RS based L3 measurement configured or only CSI-RS based L3 measurement configured.
Note 6:
N_{SCC}_{_{—}}_{SSB} = Number of configured SCell(s) with only SSB based L3 measurement configured, which is measured without MG.
Note 7:
N_{nonanchorPSCC}_{_{—}}_{SSB} refers to a number of configured non-anchor PSCC with only SSB based Layer-3 measurement, which is measured without MG.
Note 8:
N_{nonanchorPSCC}_{_{—}}_{CSIRS} refers to a number of configured non-anchor PSCC with either both SSB and CSI-RS based Layer-3 measurement configured or only CSI-RS based Layer-3 measurement configured

Although Table 2 is designed for the scenario where all serving cells in MCG are in FR1 and all serving cells in SCG are in FR2, Table 1 is also applicable to other scenarios with some slight adaptation, and such adaptation can be conceived by a person skilled in the art. For example, if all the serving cells in MCG and all the serving cells in SCG are in one frequency range (e.g. FR1 or FR2), the table will Just involve the CSSF for PCC, the CSSF for the anchor PSCC and the CSSF for SCC and non-anchor PSCC(s) determined according to the formula described in the fifth column in Table 2. For another example, if partial of the serving cells in the SCGs (e.g. the non-anchor PSCC and/or some SCC(s)) are in FR1 and the rest serving cells in the SCGs are in FR2, the third column will be adapted to CSSF_{outside_gap,i} for FR1 SCC and non-anchor PSCC which is determined according to the formula described in the fifth column in Table 2.

The second embodiment of the present disclosure has been detailly described above. With the solution of the first embodiment, RRM measurement on multiple candidates SCGs is enabled. Besides, advantageously, it is able to separately consider the anchor PSCC and to allocate suitable measurement opportunities of the second searcher to the anchor PSCC independently from the SCCs and non-anchor PSCC(s). For example, the second embodiment enables to let the anchor PSCC to get higher priority than the SCCs and non-anchor PSCC in terms of allocation of the measurement opportunities of the second searcher, since the anchor PSCC is functionally more important than the SCCs and non-anchor PSCC.

According to a variation of the second embodiment of the present disclosure, the measurement opportunities of the second searcher can be allocated according to a finer granularity. Particularly, according to such a variation, a UE can perform RRM measurement on an anchor PSCC of one or more PSCCs with a certain measurement cycle (e.g. the above-mentioned third measurement cycle or the measurement cycle for the anchor PSCC), perform RRM measurement on each of one or more non-anchor PSCCs with a certain measurement cycle (hereinafter, a fifth measurement cycle or the measurement cycle for the non-anchor PSCC), and perform RRM measurement on each of the plurality of SCCs with a certain measurement cycle (hereinafter, a sixth measurement cycle or the measurement cycle for SCC), wherein said one or more non-anchor PSCCs is all PSCC among the one or more PSCCs except the anchor PSCC. The UE can configure the third measurement cycle, fifth measurement cycle and the sixth measurement cycle such that the anchor PSCC gets a first ratio (e.g. x %, x being any suitable value from 0 to 100 including 0 and 100) of measurement opportunities of the second searcher, the one or more non-anchor PSCCs share a third ratio (e.g. y %, y being any suitable value from 0 to 100 including 0 and 100) of measurement opportunities of the second searcher, and all the SCCs share a fourth ratio (e.g. (1−x−y) %) of measurement opportunities of the second searcher, wherein the first ratio, the third ratio and the fourth ratio together consist a hundred percent.

According to such a variation, the first ratio of measurement opportunities of the second searcher for the anchor PSCC, the third ratio of measurement opportunities of the second searcher for the one or more non-anchor PSCCs, and the fourth ratio of measurement opportunities of the second searcher for all the SCCs can be predetermined (e.g. negotiated in advance between the gNB and the UE, or specified in the standard to be applied), or can be indicated via an RRC message (e.g. similar to the RRC message shown in FIG. 5 with an additional information element indicating the ratio or measurement opportunities of the non-anchor PSCC).

With such a variation, advantageously, it is able to separately consider the anchor PSCC as well as the non-anchor PSCC(s) and to allocate suitable measurement opportunities of the second searcher to the anchor PSCC and the non-anchor PSCC(s) independently from the SCCs. For example, the second embodiment enables to let the anchor PSCC to get the highest priority, and let the non-anchor PSCC(s) to get a priority lower than the anchor PSCC but higher than the SCCs in terms of allocation of the measurement opportunities of the second searcher, since the anchor PSCC is functionally more important than the SCCs and non-anchor PSCC, and the non-anchor PSCC(s) is functionally more important than the SCCs.

FIG. 7 is a flow diagram illustrating an example method for RRM measurement on multiple candidate SCGs for a wireless device (e.g. a UE).

The method starts at S702.

At S704, the wireless device may receive one or more reference signals (e.g. SSB and/or CSI-RS) from a base station.

At S706, the wireless device may perform RRM measurement outside an MG on the reference signal(s) on a PCC, one or more PSCCs and a plurality of SCCs according to the first or second embodiment as detailly described above. Particularly, the wireless device may perform RRM measurement on a PCC using a first searcher, and on one or more PSCCs corresponding to a plurality of SCGs and a plurality of SCCs using a second searcher, and particularly, the wireless device may perform the RRM measurement on each carrier of the PCC, the one or more PSCCs and the plurality of SCCs based on a respective measurement cycle.

The method ends at S708.

Embodiments contemplated herein include an apparatus comprising means to perform one or more elements of the method for RRM measurement on multiple candidate SCGs. This apparatus may be, for example, an apparatus of a UE (such as a wireless device 202 that is a UE, as described herein).

Embodiments contemplated herein include one or more non-transitory computer-readable media comprising instructions to cause an electronic device, upon execution of the instructions by one or more processors of the electronic device, to perform one or more elements of the method for RRM measurement on multiple candidate SCGs. This non-transitory computer-readable media may be, for example, a memory of a UE (such as a memory 206 of a wireless device 202 that is a UE, as described herein).

Embodiments contemplated herein include an apparatus comprising logic, modules, or circuitry to perform one or more elements of the method for RRM measurement on multiple candidate SCGs. This apparatus may be, for example, an apparatus of a UE (such as a wireless device 202 that is a UE, as described herein).

Embodiments contemplated herein include an apparatus comprising: one or more processors and one or more computer-readable media comprising instructions that, when executed by the one or more processors, cause the one or more processors to perform one or more elements of the method for RRM measurement on multiple candidate SCGs. This apparatus may be, for example, an apparatus of a UE (such as a wireless device 202 that is a UE, as described herein).

Embodiments contemplated herein include a signal as described in or related to one or more elements of the method for RRM measurement on multiple candidate SCGs.

Embodiments contemplated herein include a computer program or computer program product comprising instructions, wherein execution of the program by a processor is to cause the processor to carry out one or more elements of the method for RRM measurement on multiple candidate SCGs. The processor may be a processor of a UE (such as a processor(s) 204 of a wireless device 202 that is a UE, as described herein). These instructions may be, for example, located in the processor and/or on a memory of the UE (such as a memory 206 of a wireless device 202 that is a UE, as described herein).

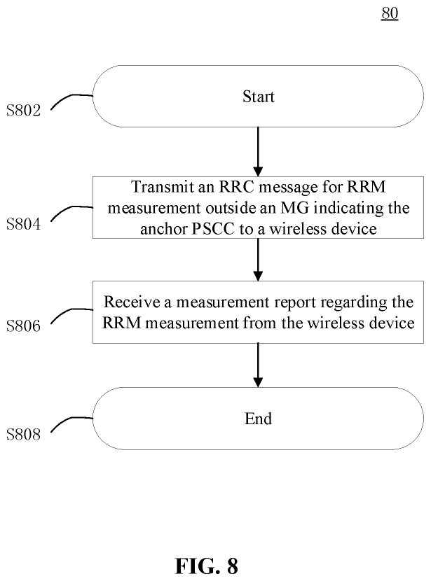

FIG. 8 is a flow diagram illustrating an example method for RRM measurement on multiple candidate SCGs for a network device (e.g., a gNB).

The method starts at S802.

At S804, the network device may transmit a first RRC message for RRM measurement outside an MG to a wireless device, wherein, the first RRC message indicates which PSCC among one or more PSCCs corresponding to a plurality of SCG is an anchor PSCC.

At S806, the network device may receive a measurement report regarding the RRM measurement from the wireless device.

The method ends at S808.

Embodiments contemplated herein include an apparatus comprising means to perform one or more elements of the method for RRM measurement on multiple candidate SCGs. This apparatus may be, for example, an apparatus of a base station (such as a network device 218 that is a base station, as described herein).

Embodiments contemplated herein include one or more non-transitory computer-readable media comprising instructions to cause an electronic device, upon execution of the instructions by one or more processors of the electronic device, to perform one or more elements of the method for RRM measurement on multiple candidate SCGs. This non-transitory computer-readable media may be, for example, a memory of a base station (such as a memory 222 of a network device 218 that is a base station, as described herein).

Embodiments contemplated herein include an apparatus comprising logic, modules, or circuitry to perform one or more elements of the method for RRM measurement on multiple candidate SCGs. This apparatus may be, for example, an apparatus of a base station (such as a network device 218 that is a base station, as described herein).

Embodiments contemplated herein include an apparatus comprising: one or more processors and one or more computer-readable media comprising instructions that, when executed by the one or more processors, cause the one or more processors to perform one or more elements of the method for RRM measurement on multiple candidate SCGs. This apparatus may be, for example, an apparatus of a base station (such as a network device 218 that is a base station, as described herein).

Embodiments contemplated herein include a signal as described in or related to one or more elements of the method for RRM measurement on multiple candidate SCGs.

Embodiments contemplated herein include a computer program or computer program product comprising instructions, wherein execution of the program by a processing element is to cause the processing element to carry out one or more elements of the method for RRM measurement on multiple candidate SCGs. The processor may be a processor of a base station (such as a processor(s) 220 of a network device 218 that is a base station, as described herein). These instructions may be, for example, located in the processor and/or on a memory of the UE (such as a memory 222 of a network device 218 that is a base station, as described herein).

Various aspects of the present disclosure have been described above. The present disclosure can be realized in various embodiments.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

The above has described in detail the RRM measurement on multiple candidate SCGs.

In addition, the present disclosure can also have any of the configurations below.

(1) A wireless device, comprising:
at least one antenna;
at least one radio coupled to the at least one antenna; and
a processor coupled to the at least one radio;
wherein the processor is configured to
receive, via the at least one radio, one or more reference signals from a cellular base station; and
perform Radio Resource Management (RRM) measurement outside a Measurement Gap (MG) on the one or more reference signals on a Primary Component Carrier (PCC) using a first searcher, and on one or more Primary Secondary Component Carriers (PSCC) corresponding to a plurality of Secondary Cell Groups (SCG) and a plurality of Secondary Component Carriers (SCC) using a second searcher,
wherein the processor is configured to perform the RRM measurement on each carrier of the PCC, the one or more PSCCs and the plurality of SCCs based on a respective measurement cycle.

(2) The wireless device of (1), wherein
the processor is further configured to perform the RRM measurement on each of the one or more PSCCs with a first measurement cycle, and to perform the RRM measurement on each of the plurality of SCCs with a second measurement cycle,
wherein processor is further configured to configure the first measurement cycle and the second measurement cycle such that all of the one or more PSCCs share 50% measurement opportunities of the second searcher and all of the plurality of SCCs share the rest 50% measurement opportunities of the second searcher.

(3) The wireless device of (2), wherein
the processor is further configured to configure the first measurement cycle such that the first measurement cycle satisfies a measurement delay scaled by a first factor for any of the one or more PSCCs, wherein the first factor depends on a number associated with the one or more PSCCs.

(4) The wireless device of (3), wherein

$$the first factor = 2 \times ( {N}_{PSCC \_ SSB} + 2 \times {N}_{PSCC \_ CRIRS} )$$

wherein:
N_{PSCC_SSB} refers to a number of configured PSCC with only Synchronization Signal Block (SSB) based Layer-3 measurement configured, and
N_{PSCC_CSIRS} refers to a number of configured PSCC with either both SSB and Channel State Information Reference Signal (CSI-RS) based Layer-3 measurement configured or only CSI-RS based Layer-3 measurement configured.

(5) The wireless device of (1), wherein
the processor is further configured to perform the RRM measurement on an anchor PSCC of the one or more PSCCs with a third measurement cycle, and to perform the RRM measurement on each carrier of one or more non-anchor PSCCs and the plurality of SCCs with a fourth measurement cycle, wherein said one or more non-anchor PSCCs is all PSCC among the one or more PSCCs except the anchor PSCC,
wherein the processor is further configured to configure the third measurement cycle and the fourth measurement cycle such that the anchor PSCC gets a first ratio of measurement opportunities of the second searcher, and the one or more non-anchor PSCCs and all of the plurality of SCCs share a second ratio of measurement opportunities of the second searcher,
wherein the first ratio and the second ratio together consist a hundred percent.

(6) The wireless device of (5), wherein
the processor is further configured to configure the third measurement cycle and the fourth measurement cycle such that the third measurement cycle satisfies a measurement delay scaled by a second factor for the anchor PSCC and the fourth measurement cycle satisfies a measurement delay scaled by a third factor for any carrier of the one or more non-anchor PSCCs and all of the plurality of SCCs, wherein
the second factor depends on a number associated with the anchor PSCC, and
the third factor at least depends on a number associated with the one or more non-anchor PSCCs.

(7) The wireless device of (6), wherein
a value of the first ratio is 50%, and
the second factor and the third factor are:

$$the second factor = 2 \times ( 1 + {N}_{anchorPSCC \_ CSIRS} ) ; and$$

$$the third factor = 2 \times ( {N}_{SCC \_ SSB} + Y + 2 \times {N}_{SCC \_ CSIRS} + {N}_{nonanchorPSCC \_ SSB} + 2 \times {N}_{nonanchorPSCC \_ CSIRS} )$$

wherein:
N_{anchorPSCC_CSIRS}=1 if the anchor PSCC is with either both Synchronization Signal Block (SSB) and Channel Information Reference Signal (CSI-RS) based Layer-3 measurement configured or only CSI-RS based Layer-3 measurement configured; otherwise, N_{anchorPSCC_CSRS}=0,
Y is the number of configured inter-frequency SSB based frequency layers without MG that are being measured outside of MG; otherwise, Y=0,
N_{SCC_SSB} refers to a number of configured Secondary Cell(s) (SCell) with only SSB based Layer-3 measurement configured,
N_{SCC_CSIRS} refers to a number of configured SCell(s) with either both SSB and CSI-RS based Layer-3 measurement configured or only CSI-RS based Layer-3 measurement configured,
N_{nonanchorPSCC_SSB} refers to a number of configured non-anchor PSCC with only SSB based Layer-3 measurement, and
N_{nonanchorPSCC_CSIRS} refers to a number of configured non-anchor PSCC with either both SSB and CSI-RS based Layer-3 measurement configured or only CSI-RS based Layer-3 measurement configured.

(8) The wireless device of (1), wherein
the processor is further configured to perform the RRM measurement on an anchor PSCC of the one or more PSCCs with a third measurement cycle, to perform the RRM measurement on each of one or more non-anchor PSCCs with a fifth measurement cycle, and to perform the RRM measurement on each of the plurality of SCCs with a sixth measurement cycle, wherein said one or more non-anchor PSCCs is all PSCC among the one or more PSCCs except the anchor PSCC,
wherein the processor is further configured to configure the third measurement cycle, fifth measurement cycle and the sixth measurement cycle such that the anchor PSCC gets a first ratio of measurement opportunities of the second searcher, the one or more non-anchor PSCCs share a third ratio of measurement opportunities of the second searcher, and all of the plurality of SCCs share a fourth ratio of measurement opportunities of the second searcher,
wherein the first ratio, the third ratio and the fourth ratio together consist a hundred percent.

(9) The wireless device of (5) or (8), wherein
in the case that one of the plurality of SCGs is active, the anchor PSCC is predetermined as a PSCC corresponding to the active SCG, or is indicated by a Primary Cell (PCell) or a Primary Secondary Cell (PSCell) via a Radio Resource Control (RRC) message; or
in the case that there is not any active SCG among the plurality of SCGs, the anchor PSCC is predetermined as a PSCC corresponding to a last active SCG of the plurality of SCGs, or the anchor PSCC is indicated by the PCell or a PSCell via an RRC message.

(10) The wireless device of (5) or (8), wherein
any one or more of the first ratio, the second ratio, the third ratio and the fourth ratio of measurement opportunities of the second searcher is predetermined or indicated via one or more Radio Resource Control (RRC) messages.

(11) The wireless device of (4) or (7), wherein
the first factor, the second factor and the third factor refer to Carrier Specific Scaling Factor (CSSF).

(12) A cellular base station, comprising:
at least one antenna;
at least one radio coupled to the at least one antenna; and
a processor coupled to the at least one radio;
wherein the processor is configured to:
   transmit, via the at least one radio, a first Radio Resource Control (RRC) message for Radio Resource Management (RRM) measurement outside a Measurement Gap (MG) to a wireless device, wherein, the first RRC message indicates which Primary Secondary Component Carrier (PSCC) among one or more PSCCs corresponding to a plurality of Secondary Cell Groups (SCG) is an anchor PSCC; and
   receive, via the at least one radio, a measurement report regarding the RRM measurement from the wireless device.

(13) The cellular base station of (12), wherein the processor is further configured to determine whether one of the plurality of SCGS is active, and
in response to determining that one of the plurality of SCGs is active, the processor determines a PSCC corresponding to the active SCG as the anchor PSCC; and
in response to determining that there is not any active SCG among the plurality of SCGs, the processor determines a PSCC corresponding to a last active SCG of the plurality of SCGs as the anchor PSCC.

(14) The cellular base station of (12) or (13), wherein the RRM measurement is performed by the wireless device on a Primary Component Carrier (PCC) using a first searcher, and on the one or more PSCCs and a plurality of Secondary Component Carriers (SCC) using a second searcher, and the processor is further configured to transmit, via the at least one radio, one or more second RRC messages to the wireless device,
wherein, the one or more second RRC messages indicates:
a first ratio specifying measurement opportunities of the second searcher that is obtained by the anchor PSCC on which the wireless device will perform the RRM measurement, or
a second ratio specifying measurement opportunities of the second searcher that is shared by one or more non-anchor PSCCs on which the wireless device will perform the RRM measurement, the one or more non-anchor PSCCs is all PSCC among the one or more PSCCs except the anchor PSCC.

(15) A method for a wireless device, comprising:
receiving one or more reference signals from a cellular base station; and
performing Radio Resource Management (RRM) measurement outside a Measurement Gap (MG) on the one or more reference signals on a Primary Component Carrier (PCC) using a first searcher, and on a one or more Primary Secondary Component Carriers (PSCC) corresponding to a plurality of Secondary Cell Groups (SCG) and a plurality of Secondary Component Carriers (SCC) using a second searcher,
wherein the method comprising performing the RRM measurement on each carrier of the PCC, the one or more PSCCs and the plurality of SCCs based on a respective measurement cycle.

(16) The method of (15), wherein
the method further comprising performing the RRM measurement on each of the one or more PSCCs with a first measurement cycle, and performing the RRM measurement on each of the plurality of SCCs with a second measurement cycle,
wherein the method further comprising configuring the first measurement cycle and the second measurement cycle such that all the one or more PSCCs share 50% measurement opportunities of the second searcher and all of the plurality of SCCs share the rest 50% measurement opportunities of the second searcher

(17) The method of (16), wherein
the method further comprising configuring the first measurement cycle such that the first measurement cycle satisfies a measurement delay scaled by a first factor for any of the one or more PSCCs, wherein the first factor depends on a number associated with the one or more PSCCs.

(18) The method of (17) wherein

$$the first factor = 2 \times ( {N}_{PSCC \_ SSB} + 2 \times {N}_{PSCC \_ CRIRS} )$$

wherein:
N_{PSCC_SSB} refers to a number of configured PSCC with only Synchronization Signal Block (SSB) based Layer-3 measurement configured, and
N_{PSCC_CSIRS} refers to a number of configured PSCC with either both SSB and Channel State Information Reference Signal (CSI-RS) based Layer-3 measurement configured or only CSI-RS based Layer-3 measurement configured.

(19) The method of (15), wherein
the method further comprising performing the RRM measurement on an anchor PSCC of the one or more PSCCs with a third measurement cycle, and performing the RRM measurement on each carrier of one or more non-anchor PSCCs and the plurality of SCCs with a fourth measurement cycle, wherein said one or more non-anchor PSCCs is all PSCC among the one or more PSCCs except the anchor PSCC,
wherein the method further comprising configuring the third measurement cycle and the fourth measurement cycle such that the anchor PSCC gets a first ratio of measurement opportunities of the second searcher, and the one or more non-anchor PSCCs and all of the plurality of SCCs share a second ratio of measurement opportunities of the second searcher,
wherein the first ratio and the second ratio together consist a hundred percent.

(20) The method of (19),
The method further comprising configuring the third measurement cycle and the fourth measurement cycle such that the third measurement cycle satisfies a measurement delay scaled by a second factor for the anchor PSCC and the fourth measurement cycle satisfies a measurement delay scaled by a third factor for any carrier of the one or more non-anchor PSCCs and all of the plurality of SCCs, wherein
the second factor depends on a number associated with the anchor PSCC, and
the third factor at least depends on a number associated with the one or more non-anchor PSCCs.

(21) The method of (20), wherein
a value of the first ratio is 50%, and
the second factor and the third factor are:

$$the second factor = 2 \times ( 1 + {N}_{anchorPSCC \_ CSIRS} ) ; and$$

$$the third factor = 2 \times ( {N}_{SCC \_ SSB} + Y + 2 \times {N}_{SCC \_ CSIRS} + {N}_{nonanchorPSCC \_ SSB} + 2 \times {N}_{nonanchorPSCC \_ CSIRS} )$$

wherein:
N_{anchorPSCC_CSIRS}=1 if the anchor PSCC is with either both Synchronization Signal Block (SSB) and Channel Information Reference Signal (CSI-RS) based Layer-3 measurement configured or only CSI-RS based Layer-3 measurement configured; otherwise, N_{anchorPSCC_CSRS}=0,
Y is the number of configured inter-frequency SSB based frequency layers without MG that are being measured outside of MG; otherwise, Y=0,
N_{SCC_SSB} refers to a number of configured Secondary Cell(s) (SCell) with only SSB based Layer-3 measurement configured,
N_{SCC_CSIRS} refers to a number of configured SCell(s) with either both SSB and CSI-RS based Layer-3 measurement configured or only CSI-RS based Layer-3 measurement configured,
N_{nonanchorPSCC_SSB} refers to a number of configured non-anchor PSCC with only SSB based Layer-3 measurement, and
N_{nonanchorPSCC_CSIRS} refers to a number of configured non-anchor PSCC with either both SSB and CSI-RS based Layer-3 measurement configured or only CSI-RS based Layer-3 measurement configured.

(22) The method of (15), wherein
the method further comprising performing the RRM measurement on an anchor PSCC of the one or more PSCCs with a third measurement cycle, performing the RRM measurement on each of one or more non-anchor PSCCs with a fifth measurement cycle, and performing the RRM measurement on all of the plurality of SCCs with a sixth measurement cycle, wherein said one or more non-anchor PSCCs is all PSCC among the one or more PSCCs except the anchor PSCC,
wherein the method further comprising configuring the third measurement cycle, fifth measurement cycle and the sixth measurement cycle such that the anchor PSCC gets a first ratio of measurement opportunities of the second searcher, the one or more non-anchor PSCCs share a third ratio of measurement opportunities of the second searcher, and all the SCCs share a fourth ratio of measurement opportunities of the second searcher,
wherein the first ratio, the third ratio and the fourth ratio together consist a hundred percent.

(23) The method of (22), wherein
in the case that one of the plurality of SCGs is active, the anchor PSCC is predetermined as a PSCC corresponding to the active SCG, or is indicated by a Primary Cell (PCell) or a Primary Secondary Cell (PSCell) via a Radio Resource Control (RRC) message; or
in the case that there is not any active SCG among the plurality of SCGs, the anchor PSCC is predetermined as a PSCC corresponding to a last active SCG of the plurality of SCGs, or the anchor PSCC is indicated by the PCell or a PSCell via an RRC message.

(24) The method of (19) or (22), wherein
any one or more of the first ratio, the second ratio, the third ratio and the fourth ratio of measurement opportunities of the second searcher is predetermined or indicated via one or more Radio Resource Control (RRC) messages.

(25) The method of (18) or (21), wherein
the first factor, the second factor and the third factor refer to Carrier Specific Scaling Factor (CSSF).

(26) A method for a cellular base station, comprising
transmitting a first Radio Resource Control (RRC) message for Radio Resource Management (RRM) measurement outside a Measurement Gap (MG) to a wireless device, wherein, the first RRC message indicates which Primary Secondary Component Carrier (PSCC) among one or more PSCCs corresponding to a plurality of Secondary Cell Groups (SCG) is an anchor PSCC; and
receiving a measurement report regarding the RRM from the wireless device.

(27) The method of (26), wherein the method further comprising determining whether one of the plurality of SCGS is active, and
in response to determining that one of the plurality of SCGs is active, the method further comprising determining a PSCC corresponding to the active SCG as the anchor PSCC; and
in response to determining that there is not any active SCG among the plurality of SCGs, the method further comprising determining a PSCC corresponding to a last active SCG of the plurality of SCGs as the anchor PSCC.

(28) The method of (26) or (27), wherein the RRM measurement is performed by the wireless device on a Primary Component Carrier (PCC) using a first searcher, and on the one or more PSCCs and a plurality of Secondary Component Carriers (SCC) using a second searcher, and the method further comprising transmitting one or more second RRC messages to the wireless device,
wherein, the one or more second RRC messages indicates:
a first ratio specifying measurement opportunities of the second searcher that is obtained by the anchor PSCC on which the wireless device will perform the RRM measurement, or
a second ratio specifying measurement opportunities of the second searcher that is shared by one or more non-anchor PSCCs on which the wireless device will perform the RRM measurement, the one or more non-anchor PSCCs is all PSCC among the one or more PSCCs except the anchor PSCC.

(29) An apparatus, comprising:
a processor configured to cause a wireless device to:
   receive, via the at least one radio, one or more reference signals from a cellular base station; and
   perform Radio Resource Management (RRM) measurement outside a Measurement Gap (MG) on the one or more reference signals on a Primary Component Carrier (PCC) using a first searcher, and on one or more Primary Secondary Component Carriers (PSCC) corresponding to a plurality of Secondary Cell Groups (SCG) and a plurality of Secondary Component Carriers (SCC) using a second searcher,
   wherein the processor is further configured to perform the RRM measurement on each carrier of the PCC, the plurality of PSCCs and the plurality of SCCs based on a respective measurement cycle.

(30) A computer-readable storage medium storing program instructions, wherein the program instructions, when executed by a computer system, cause the computer system to perform any method of (15)-(25).

(31) A computer-readable storage medium storing program instructions, wherein the program instructions, when executed by a computer system, cause the computer system to perform any method of (26)-(28).

(32) A computer program product, comprising program instructions which, when executed by a computer, cause the computer to perform any method of (15)-(25).

(33) A computer program product, comprising program instructions which, when executed by a computer, cause the computer to perform any method of (26)-(28).

1. A wireless device, comprising:
at least one antenna;
at least one radio coupled to the at least one antenna; and
a processor coupled to the at least one radio;
wherein the processor is configured to
receive, via the at least one radio, one or more reference signals from a cellular base station; and
perform Radio Resource Management (RRM) measurement outside a Measurement Gap (MG) on the one or more reference signals on a Primary Component Carrier (PCC) using a first searcher, and on one or more Primary Secondary Component Carriers (PSCC) corresponding to a plurality of Secondary Cell Groups (SCG) and a plurality of Secondary Component Carriers (SCC) using a second searcher,
wherein the processor is configured to perform the RRM measurement on each carrier of the PCC, the one or more PSCCs and the plurality of SCCs based on a respective measurement cycle.

2. The wireless device of claim 1, wherein
the processor is further configured to perform the RRM measurement on each of the one or more PSCCs with a first measurement cycle, and to perform the RRM measurement on each of the plurality of SCCs with a second measurement cycle,
wherein processor is further configured to configure the first measurement cycle and the second measurement cycle such that all of the one or more PSCCs share 50% measurement opportunities of the second searcher and all of the plurality of SCCs share the rest 50% measurement opportunities of the second searcher.

3. The wireless device of claim 2, wherein
the processor is further configured to configure the first measurement cycle such that the first measurement cycle satisfies a measurement delay scaled by a first factor for any of the one or more PSCCs, wherein the first factor depends on a number associated with the one or more PSCCs.

4. The wireless device of claim 3, wherein
$$the first factor = 2 \times ( {N}_{PSCC \_ SSB} + 2 \times {N}_{PSCC \_ CRIRS} )$$
wherein:
N_{PSCC_SSB} refers to a number of configured PSCC with only Synchronization Signal Block (SSB) based Layer-3 measurement configured, and
N_{PSCC_CSIRS} refers to a number of configured PSCC with either both SSB and Channel State Information Reference Signal (CSI-RS) based Layer-3 measurement configured or only CSI-RS based Layer-3 measurement configured.

5. The wireless device of claim 1, wherein
the processor is further configured to perform the RRM measurement on an anchor PSCC of the one or more PSCCs with a third measurement cycle, and to perform the RRM measurement on each carrier of one or more non-anchor PSCCs and the plurality of SCCs with a fourth measurement cycle, wherein said one or more non-anchor PSCCs is all PSCC among the one or more PSCCs except the anchor PSCC,
wherein the processor is further configured to configure the third measurement cycle and the fourth measurement cycle such that the anchor PSCC gets a first ratio of measurement opportunities of the second searcher, and the one or more non-anchor PSCCs and all of the plurality of SCCs share a second ratio of measurement opportunities of the second searcher,
wherein the first ratio and the second ratio together consist a hundred percent.

6. The wireless device of claim 5, wherein
the processor is further configured to configure the third measurement cycle and the fourth measurement cycle such that the third measurement cycle satisfies a measurement delay scaled by a second factor for the anchor PSCC and the fourth measurement cycle satisfies a measurement delay scaled by a third factor for any carrier of the one or more non-anchor PSCCs and all of the plurality of SCCs, wherein
the second factor depends on a number associated with the anchor PSCC, and
the third factor at least depends on a number associated with the one or more non-anchor PSCCs.

7. The wireless device of claim 6, wherein
a value of the first ratio is 50%, and
the second factor and the third factor are:
$$the second factor = 2 \times ( 1 + {N}_{anchorPSCC \_ CSIRS} ) ; and$$
$$the third factor = 2 \times ( {N}_{SCC \_ SSB} + Y + 2 \times {N}_{SCC \_ CSIRS} + {N}_{nonanchorPSCC \_ SSB} + 2 \times {N}_{nonanchorPSCC \_ CSIRS} )$$
wherein:
N_{anchorPSCC_CSIRS}=1 if the anchor PSCC is with either both Synchronization Signal Block (SSB) and Channel Information Reference Signal (CSI-RS) based Layer-3 measurement configured or only CSI-RS based Layer-3 measurement configured; otherwise, N_{anchorPSCC_CSIRS}=0,
Y is the number of configured inter-frequency SSB based frequency layers without MG that are being measured outside of MG; otherwise, Y=0,
N_{SCC_SSB} refers to a number of configured Secondary Cell(s) (SCell) with only SSB based Layer-3 measurement configured,
N_{SCC_CSIRS} refers to a number of configured SCell(s) with either both SSB and CSI-RS based Layer-3 measurement configured or only CSI-RS based Layer-3 measurement configured,
N_{nonanchorPSCC_SSB} refers to a number of configured non-anchor PSCC with only SSB based Layer-3 measurement, and
N_{nonanchorPSCC_CSIRS} refers to a number of configured non-anchor PSCC with either both SSB and CSI-RS based Layer-3 measurement configured or only CSI-RS based Layer-3 measurement configured.

8. The wireless device of claim 1, wherein
the processor is further configured to perform the RRM measurement on an anchor PSCC of the one or more PSCCs with a third measurement cycle, to perform the RRM measurement on each of one or more non-anchor PSCCs with a fifth measurement cycle, and to perform the RRM measurement on each of the plurality of SCCs with a sixth measurement cycle, wherein said one or more non-anchor PSCCs is all PSCC among the one or more PSCCs except the anchor PSCC,
wherein the processor is further configured to configure the third measurement cycle, fifth measurement cycle and the sixth measurement cycle such that the anchor PSCC gets a first ratio of measurement opportunities of the second searcher, the one or more non-anchor PSCCs share a third ratio of measurement opportunities of the second searcher, and all of the plurality of SCCs share a fourth ratio of measurement opportunities of the second searcher, wherein the first ratio, the third ratio and the fourth ratio together consist a hundred percent.

9. The wireless device of claim 8, wherein
in the case that one of the plurality of SCGs is active, the anchor PSCC is predetermined as a PSCC corresponding to the active SCG, or is indicated by a Primary Cell (PCell) or a Primary Secondary Cell (PSCell) via a Radio Resource Control (RRC) message; or
in the case that there is not any active SCG among the plurality of SCGs, the anchor PSCC is predetermined as a PSCC corresponding to a last active SCG of the plurality of SCGs, or the anchor PSCC is indicated by the PCell or a PSCell via an RRC message.

10. The wireless device of claim 8, wherein
any one or more of the first ratio, the second ratio, the third ratio and the fourth ratio of measurement opportunities of the second searcher is predetermined or indicated via one or more Radio Resource Control (RRC) messages.

11. (canceled)

12. A cellular base station, comprising:
at least one antenna;
at least one radio coupled to the at least one antenna; and
a processor coupled to the at least one radio;
wherein the processor is configured to:
transmit, via the at least one radio, a first Radio Resource Control (RRC) message for Radio Resource Management (RRM) measurement outside a Measurement Gap (MG) to a wireless device, wherein, the first RRC message indicates which Primary Secondary Component Carrier (PSCC) among one or more PSCCs corresponding to a plurality of Secondary Cell Groups (SCG) is an anchor PSCC; and
receive, via the at least one radio, a measurement report regarding the RRM measurement from the wireless device.

13. The cellular base station of claim 12, wherein the processor is further configured to determine whether one of the plurality of SCGS is active, and
in response to determining that one of the plurality of SCGs is active, the processor determines a PSCC corresponding to the active SCG as the anchor PSCC; and
in response to determining that there is not any active SCG among the plurality of SCGs, the processor determines a PSCC corresponding to a last active SCG of the plurality of SCGs as the anchor PSCC.

14. The cellular base station of claim 12, wherein the RRM measurement is performed by the wireless device on a Primary Component Carrier (PCC) using a first searcher, and on the one or more PSCCs and a plurality of Secondary Component Carriers (SCC) using a second searcher, and the processor is further configured to transmit, via the at least one radio, one or more second RRC messages to the wireless device,
wherein, the one or more second RRC messages indicates:
a first ratio specifying measurement opportunities of the second searcher that is obtained by the anchor PSCC on which the wireless device will perform the RRM measurement, or
a second ratio specifying measurement opportunities of the second searcher that is shared by one or more non-anchor PSCCs on which the wireless device will perform the RRM measurement, the one or more non-anchor PSCCs is all PSCC among the one or more PSCCs except the anchor PSCC.

15. A method for a wireless device, comprising:
receiving one or more reference signals from a cellular base station; and
performing Radio Resource Management (RRM) measurement outside a Measurement Gap (MG) on the one or more reference signals on a Primary Component Carrier (PCC) using a first searcher, and on a one or more Primary Secondary Component Carriers (PSCC) corresponding to a plurality of Secondary Cell Groups (SCG) and a plurality of Secondary Component Carriers (SCC) using a second searcher,
wherein the method comprising performing the RRM measurement on each carrier of the PCC, the one or more PSCCs and the plurality of SCCs based on a respective measurement cycle.

16. The method of claim 15, wherein
the method further comprising performing the RRM measurement on each of the one or more PSCCs with a first measurement cycle, and performing the RRM measurement on each of the plurality of SCCs with a second measurement cycle,
wherein the method further comprising configuring the first measurement cycle and the second measurement cycle such that all the one or more PSCCs share 50% measurement opportunities of the second searcher and all of the plurality of SCCs share the rest 50% measurement opportunities of the second searcher

17. The method of claim 16, wherein
the method further comprising configuring the first measurement cycle such that the first measurement cycle satisfies a measurement delay scaled by a first factor for any of the one or more PSCCs, wherein the first factor depends on a number associated with the one or more PSCCs.

18. The method of claim 17 wherein
$$the first factor = 2 \times ( {N}_{PSCC \_ SSB} + 2 \times {N}_{PSCC \_ CRIRS} )$$
wherein:
N_{PSCC_SSB} refers to a number of configured PSCC with only Synchronization Signal Block (SSB) based Layer-3 measurement configured, and
N_{PSCC_CSIRS} refers to a number of configured PSCC with either both SSB and Channel State Information Reference Signal (CSI-RS) based Layer-3 measurement configured or only CSI-RS based Layer-3 measurement configured.

19. The method of claim 15, wherein
the method further comprising performing the RRM measurement on an anchor PSCC of the one or more PSCCs with a third measurement cycle, and performing the RRM measurement on each carrier of one or more non-anchor PSCCs and the plurality of SCCs with a fourth measurement cycle, wherein said one or more non-anchor PSCCs is all PSCC among the one or more PSCCs except the anchor PSCC,
wherein the method further comprising configuring the third measurement cycle and the fourth measurement cycle such that the anchor PSCC gets a first ratio of measurement opportunities of the second searcher, and the one or more non-anchor PSCCs and all of the plurality of SCCs share a second ratio of measurement opportunities of the second searcher,
wherein the first ratio and the second ratio together consist a hundred percent.

20. The method of claim 19, further comprising configuring the third measurement cycle and the fourth measurement cycle such that the third measurement cycle satisfies a measurement delay scaled by a second factor for the anchor PSCC and the fourth measurement cycle satisfies a measurement delay scaled by a third factor for any carrier of the one or more non-anchor PSCCs and all of the plurality of SCCs, wherein
the second factor depends on a number associated with the anchor PSCC, and
the third factor at least depends on a number associated with the one or more non-anchor PSCCs.

21. The method of claim 20, wherein
a value of the first ratio is 50%, and
the second factor and the third factor are:
$$the second factor = 2 \times ( 1 + {N}_{anchorPSCC \_ CSIRS} ) ; and$$
$$the third factor = 2 \times ( {N}_{SCC \_ SSB} + Y + 2 \times {N}_{SCC \_ CSIRS} + {N}_{nonanchorPSCC \_ SSB} + 2 \times {N}_{nonanchorPSCC \_ CSIRS} )$$
wherein:
N_{anchorPSCC_CSIRS}=1 if the anchor PSCC is with either both Synchronization Signal Block (SSB) and Channel Information Reference Signal (CSI-RS) based Layer-3 measurement configured or only CSI-RS based Layer-3 measurement configured; otherwise, N_{anchorPSCC_CSIRS}=0,
Y is the number of configured inter-frequency SSB based frequency layers without MG that are being measured outside of MG; otherwise, Y=0,
N_{SCC_SSB} refers to a number of configured Secondary Cell(s) (SCell) with only SSB based Layer-3 measurement configured,
N_{SCC_CSIRS} refers to a number of configured SCell(s) with either both SSB and CSI-RS based Layer-3 measurement configured or only CSI-RS based Layer-3 measurement configured,
N_{nonanchorPSCC_SSB} refers to a number of configured non-anchor PSCC with only SSB based Layer-3 measurement, and
N_{nonanchorPSCC_CSIRS} refers to a number of configured non-anchor PSCC with either both SSB and CSI-RS based Layer-3 measurement configured or only CSI-RS based Layer-3 measurement configured.

22-33. (canceled)
